(19) United States
(12) Patent Application Publication
(10) Pub. No.: US 2025/0104233 A1
(43) Pub. Date: Mar. 27, 2025

(54) DYNAMIC IMAGE PROCESSING APPARATUS, MOBILE VEHICLE, DYNAMIC IMAGE PROCESSING METHOD, AND NON-TRANSITORY COMPUTER-READABLE RECORDING MEDIUM STORING DYNAMIC IMAGE PROCESSING PROGRAM

(71) Applicant: Konica Minolta, Inc., Tokyo (JP)

(72) Inventor: Takuya Yamamura, Tokyo (JP)

(73) Assignee: Konica Minolta, Inc., Tokyo (JP)

(21) Appl. No.: 18/892,719

(22) Filed: Sep. 23, 2024

(30) Foreign Application Priority Data
Sep. 27, 2023 (JP) 2023-165895

(51) Int. Cl. G06T 7/00

(52) U.S. Cl. CPC G06T 7/0012; G06T 2207/30061

(57) ABSTRACT

Provided is a dynamic image processing apparatus that includes: at least one hardware processor; and an outputter that outputs information on a setting value of a respiratory assistance apparatus, and the at least one hardware processor extracts the information by processing at least one dynamic image imaged by irradiating lungs of a subject, who is put on the respiratory assistance apparatus, with radiation.

### CROSS REFERENCE TO RELATED APPLICATIONS

The entire disclosure of Japanese Patent Application No. 2023-165895, filed on Sep. 27, 2023, is incorporated herein by reference in its entirety.

### BACKGROUND

### Technological Field

The present invention relates to a dynamic image processing apparatus, a mobile vehicle, a dynamic image processing method, and a non-transitory computer-readable recording medium storing a dynamic image processing program.

### Description of Related Art

For a patient, in particular, an unconscious patient, who is put on a respirator, it is necessary to set the respirator to an optimum value and operate the respirator such that atelectasis or damage to the lungs does not occur. Although the amount of ventilation can be known from the respirator, the respirator merely views the lungs as a single balloon, and cannot grasp the state of local ventilation of the lungs. In order to prevent atelectasis or damage to the lungs, it is necessary to set the respirator to an optimum value after grasping the state of local ventilation of the lungs.

A method using electrical impedance tomography (EIT) is known as a method for observing the state of local ventilation of the lungs (for example, Japanese Patent Publication Laid-Open No. 2013-063186). In this method, a belt with electrodes is attached to the chest of a patient, the impedance (electrical resistance) of the lungs is measured, and a change in the state of ventilation (aeration) is observed based on a change in the impedance.

The EIT is used exclusively by one patient, and a facility including only a few units thereof has difficulty using the few units among patients at the same time, and there are problems of a risk of moving a patient when wrapping a belt of the EIT and a bedsore due to the belt. In addition, it is also a risk that a patient (for example, a patient in an intensive care unit) put on a respirator is transported to a computed tomography (CT) room and is subjected to a close examination.

Accordingly, it is desired to grasp the state of local ventilation of the lungs and set an optimum setting value to a respirator without imposing a burden on a patient.

### SUMMARY

An object of the present invention is to provide a dynamic image processing apparatus, a dynamic image processing method, and a non-transitory computer-readable recording medium storing a dynamic image processing program, each of which is capable of grasping the state of local ventilation of the lungs and setting an optimum setting value to a respirator without imposing a burden on a patient.

In order to realize at least one of the above-described objects, a dynamic image processing apparatus reflecting one aspect of the present invention includes: at least one hardware processor; and an outputter that outputs information on a setting value of a respiratory assistance apparatus, and the at least one hardware processor extracts the information by processing at least one dynamic image imaged by irradiating lungs of a subject, who is put on the respiratory assistance apparatus, with radiation.

In order to achieve at least one of the above-described objects, a mobile vehicle reflecting one aspect of the present invention includes: the dynamic image processing apparatus described above; a dynamic image imaging apparatus that images the at least one dynamic image and inputs the at least one dynamic image to the dynamic image processing apparatus; and a cart on which the dynamic image processing apparatus and the dynamic image imaging apparatus are mounted and which is configured to be movable.

In order to achieve at least one of the above-mentioned objects, a dynamic image processing method reflecting an aspect of the present invention includes: extracting information on a setting value of a respiratory assistance apparatus by processing at least one dynamic image imaged by irradiating lungs of a subject, who is put on the respiratory assistance apparatus, with radiation; and outputting the information.

In order to achieve at least one of the above objects, a non-transitory computer-readable recording medium storing a dynamic image processing program reflecting an aspect of the present invention is a non-transitory computer-readable recording medium storing a dynamic image processing program that causes a computer to execute: extracting information on a setting value of a respiratory assistance apparatus by processing at least one dynamic image imaged by irradiating lungs of a subject, who is put on the respiratory assistance apparatus, with radiation; and outputting the information.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically illustrating a mobile vehicle including a dynamic image processing apparatus and a dynamic image imaging apparatus according to an embodiment of the present invention;

FIG. 2 is a block diagram schematically illustrating the mobile vehicle illustrated in FIG. 1;

FIG. 3 is a diagram illustrating an example of a dynamic image processed in the PL mode (in which an extracted signal change amount is visualized);

FIG. 4 is a graph illustrating, with respect to a plurality of dynamic images at each different setting value of a respirator, left-right ratios in association with the different setting value, where the left-right ratios are obtained as ratios between signal change amounts corresponding to the left and right lungs extracted in the PL mode;

FIG. 5 is a graph illustrating, with respect to a plurality of dynamic images at each different setting value of the respirator, signal change amounts between exhalation and inhalation in association with the different setting value, where the signal change amounts between exhalation and inhalation are obtained for the respective signal change amounts corresponding to the left lung, right lung, and both lungs extracted in the PL mode;

FIG. 6 is a graph illustrating collapse ratios and overdistension ratios in association with the different setting value, where each of the collapse ratios is a ratio of a collapsed region to the entire lung field and each of the overdistension ratios is a ratio of an overdistension region to the entire lung field;

FIG. 7 is a diagram illustrating an example in which the lung fields are divided into a plurality of regions in a dynamic image imaged by the dynamic image imaging apparatus;

FIG. 8A is a graph illustrating, with respect to a plurality of dynamic images at each different setting value of the respirator, left-right ratios in association with the different setting value, where the left-right ratios are obtained as ratios between signal change amounts corresponding to an upper left lung and an upper right lung extracted in the PL mode;

FIG. 8B is a graph illustrating, with respect to a plurality of dynamic images at each different setting value of the respirator, left-right ratios in association with the different setting value, where the left-right ratios are obtained as ratios between signal change amounts corresponding to a middle left lung and a middle right lung extracted in the PL mode;

FIG. 8C is a graph illustrating, with respect to a plurality of dynamic images at each different setting value of the respirator, left-right ratios in association with the different setting value, where the left-right ratios are obtained as ratios between signal change amounts corresponding to a lower left lung and a lower right lung extracted in the PL mode;

FIG. 9 is a graph illustrating, with respect to a plurality of dynamic image imaged at different dates and times, signal change amounts between exhalation and inhalation in association with the dates and times, where the signal change amounts between exhalation and inhalation are obtained for the respective signal change amounts corresponding to the left lung, right lung, and both lungs extracted in the PL mode;

FIG. 10 is a table illustrating, with respect to a plurality of dynamic images imaged at different dates and times, left-right ratios and respirator settings in association with the dates and times, where the left-right ratios are obtained as ratios between signal change amounts corresponding to the left and right lungs extracted in the PL mode; and

FIG. 11 is a diagram illustrating an example in which a dynamic image and a plurality of graphs are displayed at the same time.

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, an embodiment of the present invention will be described in detail with reference to the accompanying drawings.

### [Mobile Vehicle]

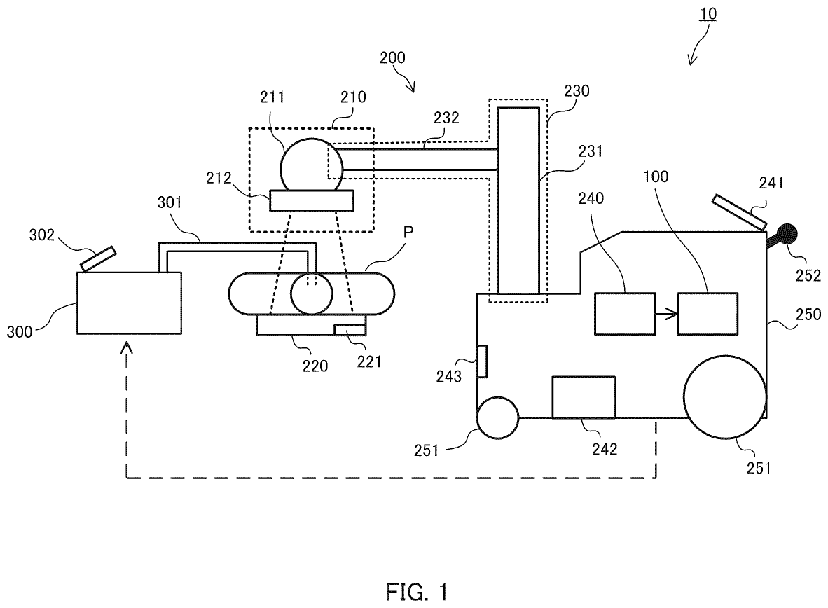

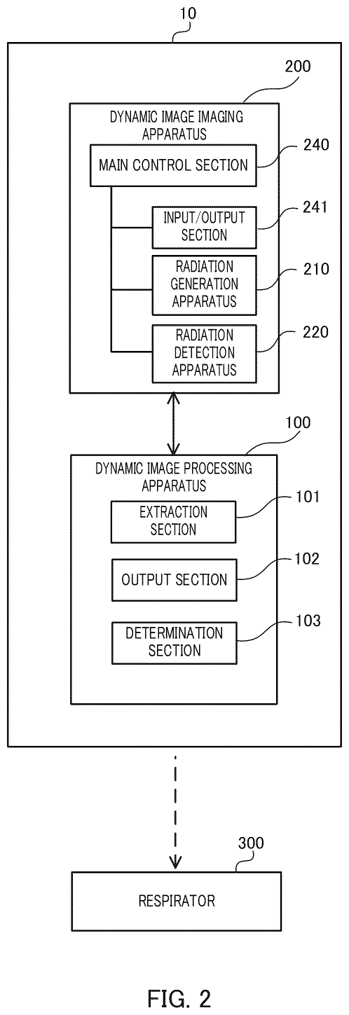

FIG. 1 is a diagram schematically illustrating mobile vehicle 10 including dynamic image processing apparatus 100 and dynamic image imaging apparatus 200 according to the present embodiment. FIG. 2 is a block diagram schematically illustrating mobile vehicle 10 illustrated in FIG. 1. FIG. 2 is a block diagram schematically illustrating mobile vehicle 10 illustrated in FIG. 1. Note that, FIG. 1 is a diagram illustrating an example of mobile vehicle 10 in use.

Mobile vehicle 10 includes dynamic image processing apparatus 100 and dynamic image imaging apparatus 200. Mobile vehicle 10 is configured to move so as to be accessible to a patient P (subject) put on respirator 300. Respirator 300 is an example of the respiratory assistance apparatus in the present invention.

Here, respirator 300 will be briefly described. Respirator 300 is an apparatus that performs mechanical ventilation and artificial respiration by taking respiratory gas into and out of the lungs in order to assist patient P, who cannot breathe or does not breathe well, the respiration. There are several methods for putting on respirator 300, and for patient P in an intensive care unit, for example, tracheal intubation in which tube 301 is intubated into the trachea from the mouth or the nose, tracheotomy in which the trachea is incised and tube 301 is intubated into the trachea, or the like is used.

In respirator 300, it is desired to set an optimum setting value, and in the present embodiment, as will be described later, dynamic image processing apparatus 100 is configured to acquire information on setting values and to present the information to a medical worker who is the user. Furthermore, dynamic image processing apparatus 100 may be configured to determine the optimum setting value, as described later.

Accordingly, dynamic image processing apparatus 100 is configured to acquire information on setting values of respirator 300 by processing a dynamic image through from dynamic image imaging apparatus 200. Dynamic image imaging apparatus 200 is configured to image a dynamic image of the lungs of patient P and input the dynamic image to dynamic image processing apparatus 100. The dynamic image is an image imaging the movement of the affected part (here, the lungs) of patient P.

Here, in one example, dynamic image processing apparatus 100 and dynamic image imaging apparatus 200 are mounted on mobile vehicle 10, and a dynamic image can be inputted from dynamic image imaging apparatus 200 to dynamic image processing apparatus 100.

Note that, dynamic image processing apparatus 100 does not necessarily have to be mounted on mobile vehicle 10 as long as dynamic image processing apparatus 100 is configured such that a dynamic image can be inputted from dynamic image imaging apparatus 200 to dynamic image processing apparatus 100. For example, dynamic image processing apparatus 100 may be configured such that dynamic image processing apparatus 100 is connected to dynamic image imaging apparatus 200 by wireless communication or the like, and a dynamic image can be inputted to dynamic image processing apparatus 100.

Dynamic image processing apparatus 100 and dynamic image imaging apparatus 200 included in mobile vehicle 10 will be described below, including other configurations.

### (Dynamic Image Imaging Apparatus)

First, dynamic image imaging apparatus 200 will be described. Dynamic image imaging apparatus 200 includes radiation generation apparatus 210, radiation detection apparatus 220, arm 230, and the like. Dynamic image imaging apparatus 200 has a plurality of imaging modes such as a dynamic imaging mode and a fluoroscopic imaging mode as imaging modes. Hereinafter, the dynamic imaging mode will be mainly described.

### (Dynamic Image Imaging Apparatus-Radiation Generation Apparatus)

Radiation generation apparatus 210 includes generator 211 and collimator 212.

Generator 211 includes a tube. When a voltage is applied to the tube and a current flows, radiation is emitted from the tube. A pulsed voltage may be applied to the tube, and pulsed radiation, for example, X-rays may be emitted from the tube.

The maximum amount of radiation that generator 211 emits, that is, the allowed amount of radiation is limited according to the set imaging mode. In the dynamic imaging mode, the amount of radiation to be emitted is limited due to limitations as a general imaging apparatus.

In addition, generator 211 emits radiation on the basis of imaging conditions set through input/output section 241 to be described later. The imaging conditions are conditions relating to radiation emission, such as a tube voltage, a tube current, an irradiation time, a current-time product (mAs value), a frame rate, the allowable number of frames, a pulse width, a pulse interval, a pulse cycle, and a pulse duty ratio. In addition, as the imaging conditions, for example, conditions related to patient P, such as an imaging site, the imaging direction, and the physique, are also set.

In the dynamic imaging mode, radiation generation apparatus 210 repeatedly emits radiation pulses at a cycle of a plurality of times per unit time (for example, 15 times per second) for a predetermined time (duration) while an emission instruction is issued. Here, the dynamic imaging mode will be described by taking, as an example, a case in which radiation pulses are emitted, but may be a case in which radiation is continuously emitted.

Collimator 212 narrows the irradiation field of the emitted radiation. Collimator 212 may include a shielding member such as a filter. The shielding member may narrow a region to be irradiated with the emitted radiation. The shielding member may weaken the intensity of the emitted radiation.

### (Dynamic Image Imaging Apparatus-Radiation Detection Apparatus)

Radiation detection apparatus 220 includes a sensor board, a scanning circuit, a readout circuit, a detection control section (not illustrated), communication section 221, and the like, and detects, through patient P, radiation emitted from radiation generation apparatus 210. Patient P is a human, but may be an animal or the like.

In the sensor board, pixels are arranged two-dimensionally (in a matrix). Each pixel includes a radiation detection element that generates an electric charge corresponding to the dose of radiation received through a subject, and a switch element that accumulates and discharges the electric charge. The scanning circuit turns on or off each switch element. The readout circuit reads out the amount of charge emitted from each pixel as a signal value (intensity).

The detection control section controls radiation detection apparatus 220 in its entirety. The detection control section generates a radiographic image from a plurality of signal values read by the readout circuit.

Communication section 221 transmits the data of the radiographic image generated by the readout circuit, various signals, and the like to the outside. Further, communication section 221 receives various kinds of information and various signals. Communication section 221 may perform wireless communication or may perform wired communication.

In each pixel of radiation detection apparatus 220 configured in the above-described manner, when the radiation detection element receives radiation in a state in which the scanning circuit turns off the switch element, the radiation detection element generates electric charge corresponding to the dose of radiation and accumulates the electric charge. When the scanning circuit turns on the switch element, the accumulated charge is released, and the readout circuit detects the amount of charge released from each pixel and generates a signal value indicating the amount of charge.

The detection control section generates a radiographic image based on the signal value generated for each pixel. Each of the generated radiographic images is one static image in the dynamic imaging. In the case of pulsed radiation, one static image is generated for each pulse.

Communication section 221 communicates with communication section 243 mounted on cart 250, which will be described later, and transmits the generated radiographic image to communication section 243. Communication section 221 may transmit the static image to communication section 243 each time one static image is generated, or may collectively transmit a plurality of static images to communication section 243. Communication section 221 may communicate with a component other than communication section 243. The communication performed by communication section 221 may be wireless communication or wired communication.

In a case where radiation generation apparatus 210 performs pulse emission, the timing of generating a plurality of static images constituting a dynamic image is synchronized with the timing of emitting radiation from radiation generation apparatus 210. In a case where radiation generation apparatus 210 performs continuous emission, on the other hand, the generation of a plurality of static images constituting a dynamic image is performed at an arbitrary timing during the time of continuous emission.

When in use, radiation detection apparatus 220 is driven by an internal battery and is wirelessly connected to a main control section 240 which will be described later. Note that, radiation detection apparatus 220 may be supplied with power from cart 250 in a wired or wireless manner.

Radiation detection apparatus 220 may be stored in a storage section (not illustrated) provided in cart 250 when mobile vehicle 10 is in move or not used. At this time, radiation detection apparatus 220 is connected to main control section 240 in a wired manner, and communication and charging with respect to radiation detection apparatus 220 are performed. Note that, at this time, communication with and charging of radiation detection apparatus 220 may be performed wirelessly.

### (Dynamic Image Imaging Apparatus-Arm)

Arm 230 includes vertical arm 231 and horizontal arm 232. Vertical arm 231 rotatably supports horizontal arm 232 around its axis. Vertical arm 231 may also support horizontal arm 232 such that horizontal arm 232 is movable in the horizontal direction. Horizontal arm 232 rotatably supports radiation generation apparatus 210 around its axis.

Radiation generation apparatus 210 can be disposed in a position and in an orientation in which radiation generation apparatus 210 faces patient P by vertical arm 231 and horizontal arm 232. Vertical arm 231 and horizontal arm 232 may be rotatable and movable under the control of main control section 240 based on the input from input/output section 241, or may be rotatable and movable manually.

### (Dynamic Image Imaging Apparatus-Main Control Section or the Like)

Dynamic image imaging apparatus 200 further includes main control section 240, input/output section 241, power supply section 242, communication section 243, and the like.

Main control section 240 controls mobile vehicle 10 in its entirety. In a case where cart 250 includes a driving apparatus, main control section 240 controls not only dynamic image imaging apparatus 200 but also the driving apparatus of cart 250. Here, dynamic image processing apparatus 100 is provided separately from main control section 240, but main control section 240 may also function as dynamic image processing apparatus 100.

Main control section 240 is a so-called computer, and is constituted by a central processing unit (CPU), a random access memory (RAM), a read only memory (ROM), and the like. In main control section 240, the CPU reads various programs such as a system program and a processing program stored in the ROM, develops the programs in the RAM, and executes various pieces of processing according to the developed programs.

Input/output section 241 includes an input section and an output section. In input/output section 241, the input section and the output section may be separated from each other. Input/output section 241 may include a touch screen, a keyboard, a mouse, a microphone, and a camera that function as the input section, and a display, a speaker, a display lamp, and the like that function as the output section. Input/output section 241 may be capable of voice input, gesture input, and the like.

Input/output section 241 inputs, to main control section 240, settings and operations by the user. Input/output section 241 may also settings and operations by the user to dynamic image processing apparatus 100 via main control section 240. Further, input/output section 241 displays a dynamic image imaged by dynamic image imaging apparatus 200, information acquired by dynamic image processing apparatus 100, and the like.

Power supply section 242 supplies power to mobile vehicle 10 in its entirety. Power supply section 242 may charge radiation detection apparatus 220 by supplying power not only to dynamic image processing apparatus 100 and dynamic image imaging apparatus 200 but also to radiation detection apparatus 220.

Power supply section 242 may be constituted by a rechargeable battery that can be charged by being connected to a commercial power supply or the like. As the rechargeable battery, for example, a nickel-metal hydride battery, a lithium-ion battery, a sodium battery, or the like can be used. In this case, power supply section 242 may be connected to the commercial power supply or the like so as to be charged when mobile vehicle 10 is not used, and may be disconnected from the commercial power supply so as to be supplied with power by a battery when mobile vehicle 10 is in use. Note that, power supply section 242 is not limited to the rechargeable battery, but another power supply may be used, for example, a fuel cell or the like may be used.

Communication section 243 communicates with communication section 221 of radiation detection apparatus 220. Communication section 243 transmits setting and an instruction, which are set by input/output section 241, to communication section 221. Further, communication section 243 outputs a radiographic image received from communication section 221 to main control section 240.

Communication section 243 may communicate with a component other than communication section 221, for example, respirator 300. Furthermore, communication section 243 may communicate with a medical system or the like. Examples of the medical system include a hospital information system (HIS), a radiology information system (RIS), and a picture archiving and communication system (PACS).

### (Cart)

Dynamic image processing apparatus 100 and dynamic image imaging apparatus 200 are mounted in cart 250, and cart 250 is configured to be movable by wheels 251. The movement of cart 250 may be performed manually or driven by a driving apparatus.

When mobile vehicle 10 is manually moved, handle 252 is held by a person to move mobile vehicle 10. When mobile vehicle 10 is moved by the driving apparatus, for example, the motor drives some of wheels 251 as driving wheels by electric power supplied from power supply section 242 to move mobile vehicle 10. At this time, handle 252 may be steered by a person to steer mobile vehicle 10. When dynamic image imaging apparatus 200 is in use, wheels 251 are locked to fix the position of mobile vehicle 10 such that mobile vehicle 10 does not move.

With the above-described configuration, mobile vehicle 10 moves to the vicinity (beside the bed) of patient P put on respirator 300, and dynamic image imaging apparatus 200 irradiates the lungs of patient P with radiation to image a dynamic image. Then, as described below, dynamic image processing apparatus 100 acquires information on a setting value of respirator 300 from the imaged dynamic image.

### (Dynamic Image Processing Apparatus)

Dynamic image processing apparatus 100 is configured to acquire information on a setting of respirator 300 by processing a dynamic image inputted from dynamic image imaging apparatus 200. Dynamic image processing apparatus 100 is, for example, a computer including at least one hardware processor, and is constituted by a CPU, a RAM, a ROM, and the like. The dynamic image processing program is stored in a non-transitory computer-readable recording medium, and the dynamic image processing program is stored in the ROM from the recording medium. In dynamic image processing apparatus 100, the CPU reads a dynamic image processing program stored in the ROM, develops the dynamic image processing program in the RAM, and executes a dynamic image processing method of processing a dynamic image according to the developed program.

Note that, as described above, main control section 240 may also function as dynamic image processing apparatus 100, but here, as an example, dynamic image processing apparatus 100 will be described as an apparatus separate from main control section 240.

As described above, dynamic image imaging apparatus 200 images a dynamic image by irradiating the lungs of patient P, who is put on respirator 300, with radiation. Dynamic image processing apparatus 100 includes, as its functions, extraction section 101 that extracts information on setting values of respirator 300 by processing a dynamic image inputted from dynamic image imaging apparatus 200, and output section 102 (an outputter in the present invention) that outputs the extracted information. In dynamic image processing apparatus 100, at least one hardware processor function as extraction section 101, output section 102, and determination section 103 to be described later.

More specifically, extraction section 101 has, as a processing mode for processing at least one dynamic image, at least a mode (hereinafter referred to as the PL mode) for extracting a signal change amount in a time direction in a specific time-frequency band concerning respiration in each pixel and visualizing the signal change amount. Thus, the behavior of the lung tissue during respiration can be visualized.

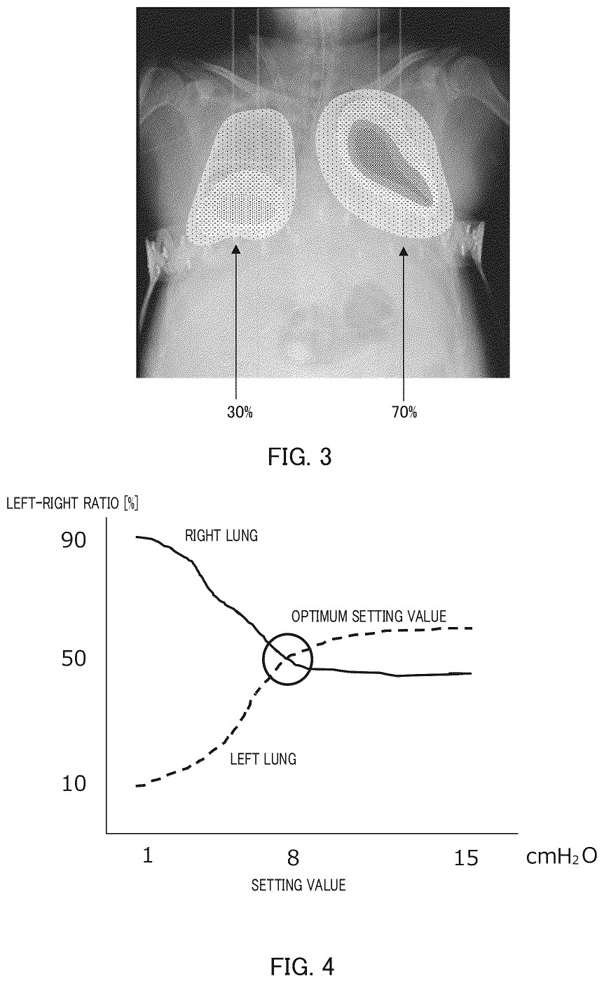

Extraction section 101 is configured to perform predetermined processing on a signal change amount extracted in the PL mode to output at least information related to setting values of respirator 300 to input/output section 241 via output section 102. The processing of extraction section 101 will be described later with reference to FIGS. 3 to 8.

Output section 102 outputs the above-mentioned information and the above-mentioned optimum setting value to input/output section 241, and input/output section 241 displays the information and the optimum setting value. Output section 102 may output the information and the optimum setting value to respirator 300 via main control section 240, communication section 243, and a cable (illustration is omitted).

Furthermore, dynamic image processing apparatus 100 may include determination section 103 that determines an optimum setting value with respect to setting values of respirator 300 on the basis of the information extracted by extraction section 101, and this optimum setting value is also outputted from output section 102.

Note that, dynamic image imaging apparatus 200 may have the PL mode, and in that case, dynamic image processing apparatus 100 may not perform the processing in the PL mode.

### (Processing Example 1 in Dynamic Image Processing Apparatus)

FIG. 3 is a diagram illustrating an example of a dynamic image processed in the PL mode. FIG. 4 is a graph illustrating, with respect to a plurality of dynamic images at each different setting value of respirator 300, left-right ratios in association with the different setting value, where the left-right ratios are obtained as ratios between signal change amounts corresponding to the left and right lungs extracted in the PL mode.

In the present processing example, extraction section 101 of dynamic image processing apparatus 100 obtains, with respect to a plurality of dynamic images at each different setting value of respirator 300, the left-right ratios between signal change amounts corresponding to the left and right lungs extracted in the PL mode. The different setting values may include a reference setting value of respirator 300. The reference setting value can be set based on the height and the weight of patient P.

For example, FIG. 3 is a diagram illustrating an example of a dynamic image, for which a positive end expiratory pressure (PEEP) that is a setting value of respirator 300 on which patient P is put is set to a certain value and imaging is performed on patient P, and which is processed in the PL mode. Note that, the positive end expiratory pressure is a positive pressure applied to the alveoli such that the airway pressure does not become 0 cmH₂O at the time of the end of expiration (such that the alveoli do not completely collapse).

In FIG. 3, as an example, the shading of the dot pattern is changed according to the magnitude of the signal change amount in each pixel, and as the signal change amount becomes larger, the density of the dot pattern becomes darker and the dot pattern is displayed so as to be superimposed on the dynamic image imaged by dynamic image imaging apparatus 200. Note that, in FIG. 3, the magnitude of the signal change amount is expressed by the gradation of the dot pattern, but the present invention is not limited thereto, and for example, the magnitude of the signal change amount may be expressed by a difference in hue or the like.

Extraction section 101 obtains, in the dynamic image after the PL mode processing illustrated in FIG. 3, the left-right ratio between signal change amounts corresponding to the left and right lungs extracted in the PL mode. For example, in FIG. 3, the left-right ratio between the signal change amounts is 30% for the left lung to 70% for the right lung, where the signal change amounts corresponding to the left and right lungs are 100%. Extraction section 101 obtains the left-right ratios between the signal change amounts with respect to a plurality of dynamic images at each different setting value of respirator 300.

Then, as illustrated in FIG. 4, extraction section 101 graphs the left-right ratios between the signal change amounts with respect to the setting values. The graph illustrated in FIG. 4 becomes information on setting values of respirator 300 extracted by extraction section 101.

Output section 102 outputs the graph illustrated in FIG. 4 to input/output section 241, and input/output section 241 displays the graph illustrated in FIG. 4. The user (medical worker) refers to the graph displayed on input/output section 241 and determines the optimum setting value. For example, the user determines a setting value, at which the left-right ratio between the signal change amounts is 50%:50%, as the optimum setting value. Then, the user sets the optimum setting value through input/output section 302 of respirator 300 as the setting value of respirator 300.

Furthermore, in a case where dynamic image processing apparatus 100 includes determination section 103, determination section 103 determines the optimum setting value by referring to the graph illustrated in FIG. 4, output section 102 outputs the determined optimum setting value to input/output section 241, and input/output section 241 displays the determined optimum setting value. The user refers to the optimum setting value displayed on input/output section 241, and sets the optimum setting value to respirator 300 through input/output section 302. In this case, output section 102 may transmit the optimum setting value to respirator 300 via communication section 243 or the cable, and respirator 300 may set the transmitted optimum setting value as the setting value of respirator 300.

In the present processing example, the number of dynamic images to be processed is preferably large, but it is sufficient that at least two dynamic images at each different setting value of respirator 300 are provided. In a case where the number of dynamic images is small, the value of the left-right ratio is approximated by a quadratic function or a linear function and graphed.

As described above, in the present processing example, dynamic image processing apparatus 100 is configured to extract information on setting values of respirator 300 from dynamic images and to present the information.

The dynamic image imaging by dynamic image imaging apparatus 200 described above does not impose a burden on a patient. Since dynamic image processing apparatus 100 extracts the magnitude of the signal change amount in each pixel, it is possible to grasp the behavior of the lung tissue corresponding to the pixel, that is, the state of local ventilation of the lungs. As a result, dynamic image processing apparatus 100 can grasp the state of local ventilation of the lungs without imposing a burden on a patient, and present information such that an optimum setting value can be set to respirator 300.

### (Processing Example 2 in Dynamic Image Processing Apparatus)

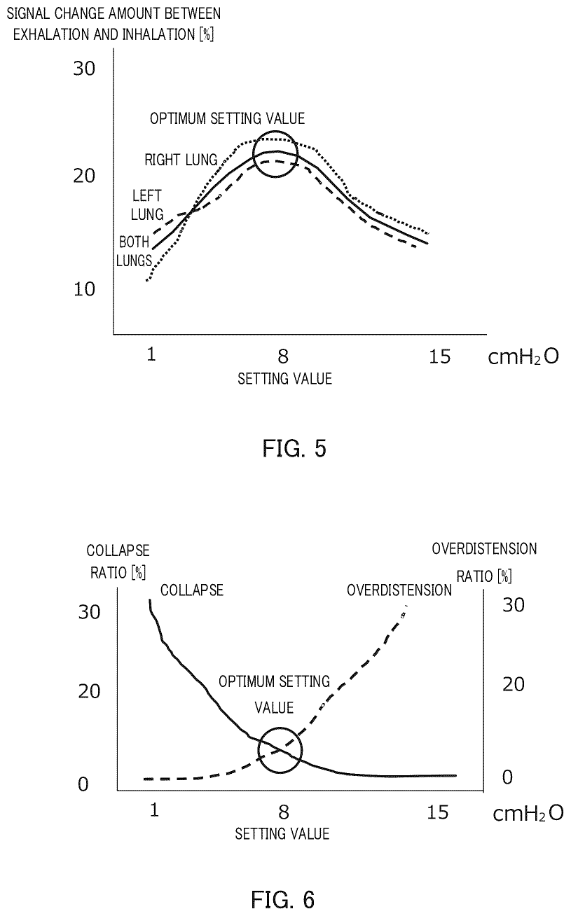

FIG. 5 is a graph illustrating, with respect to a plurality of dynamic images at each different setting value of respirator 300, signal change amounts between exhalation and inhalation in association with the different setting value, where the signal change amounts between exhalation and inhalation are obtained for the respective signal change amounts corresponding to the left lung, right lung, and both lungs extracted in the PL mode;

In the present processing example, extraction section 101 of dynamic image processing apparatus 100 obtains, with respect to a plurality of dynamic images at each different setting value of respirator 300, signal change amounts between exhalation and inhalation for the respective signal change amounts corresponding to the left lung, right lung, and both lungs extracted in the PL mode.

Then, as illustrated in FIG. 5, extraction section 101 graphs the signal change amounts between exhalation and inhalation in the left lung, right lung, and both lungs with respect to the setting values. The graph illustrated in FIG. 5 becomes information on setting values of respirator 300 extracted by extraction section 101.

Thereafter, dynamic image processing apparatus 100 performs the same processing as in processing example 1. The user refers to the graph (the graph illustrated in FIG. 5) displayed on input/output section 241 and determines the optimum setting value. For example, the user determines a setting value, at which the signal change amount is the largest, as the optimum setting value. Then, the user sets the optimum setting value to respirator 300 through input/output section 302 as the setting value of respirator 300.

Furthermore, even in a case where dynamic image processing apparatus 100 includes determination section 103, dynamic image processing apparatus 100 performs the same processing as in processing example 1. The user refers to the optimum setting value displayed on input/output section 241, and sets the optimum setting value to respirator 300 through input/output section 302. In this case, output section 102 may transmit the optimum setting value to respirator 300 via communication section 243 or the cable, and respirator 300 may set the transmitted optimum setting value as the setting value of respirator 300.

Even in the present processing example, the number of dynamic images to be processed is preferably large, but it is sufficient that at least two dynamic images at each different setting value of respirator 300 are provided. In a case where the number of dynamic images is small, the value of the left-right ratio is approximated by a quadratic function or a linear function and graphed.

In addition, the graph illustrated in FIG. 5 may be created by performing the above-described present processing example not for the entire lung field but for a partial region of interest.

As described above, even in the present processing example, dynamic image processing apparatus 100 is configured to extract information on setting values of respirator 300 from dynamic images and to present the information.

The present processing example is different from processing example 1 described above only in the processing (arithmetic processing) performed by extraction section 101. Accordingly, even in the present processing example, dynamic image processing apparatus 100 can grasp the state of local ventilation of the lungs without imposing a burden on a patient, and present information such that an optimum setting value can be set to respirator 300.

### (Processing Example 3 in Dynamic Image Processing Apparatus)

FIG. 6 is a graph illustrating collapse ratios and overdistension ratios in association with the different setting value, where each of the collapse ratios is a ratio of a collapsed region to the entire lung field and each of the overdistension ratios is a ratio of an overdistension region to the entire lung field

In the present processing example, extraction section 101 of dynamic image processing apparatus 100 decreases the setting value of respirator 300 from a high value, regards a region in which the signal change amount between exhalation and inhalation extracted in the PL mode is lower than that in the previous setting value as a collapsed region, and obtains the ratio of the collapsed region to the entire lung field. In addition, extraction section 101 increases the setting value of respirator 300 from a low value, regards a region in which the signal change amount between exhalation and inhalation extracted in the PL mode is lower than that in the previous setting value as an overdistension region, and obtains the ratio of the overdistension region to the entire lung field.

Then, as illustrated in FIG. 6, extraction section 101 graphs ratios of collapsed regions and ratios of overdistension regions with respect to setting values. The graph illustrated in FIG. 6 becomes information on setting values of respirator 300 extracted by extraction section 101.

Thereafter, dynamic image processing apparatus 100 performs the same processing as in processing example 1. The user refers to the graph (the graph illustrated in FIG. 6) displayed on input/output section 241 and determines the optimum setting value. For example, the user determines a setting value corresponding to a position, in which a graph illustrating the ratio of collapsed region and a graph illustrating the ratio of overdistension region intersect each other, as the optimum setting value. Then, the user sets the optimum setting value to respirator 300 through input/output section 302 as the setting value of respirator 300.

Furthermore, even in a case where dynamic image processing apparatus 100 includes determination section 103, dynamic image processing apparatus 100 performs the same processing as in processing example 1. The user refers to the optimum setting value displayed on input/output section 241, and sets the optimum setting value to respirator 300 through input/output section 302. In this case, output section 102 may transmit the optimum setting value to respirator 300 via communication section 243 or the cable, and respirator 300 may set the transmitted optimum setting value as the setting value of respirator 300.

Even in the present processing example, the number of dynamic images to be processed is preferably large, but it is sufficient that at least two dynamic images at each different setting value of respirator 300 are provided. When the number of dynamic images is small, the value of the left-right ratio is approximated by a quadratic function or a linear function and graphed.

As described above, even in the present processing example, dynamic image processing apparatus 100 configured to extract information on setting values of respirator 300 from the dynamic image and to present the information.

The present processing example is also different from processing example 1 described above only in the processing (arithmetic processing) performed by extraction section 101. Accordingly, even in the present processing example, dynamic image processing apparatus 100 can grasp the state of local ventilation of the lungs without imposing a burden on a patient, and present information such that an optimum setting value can be set to respirator 300.

### (Processing Example 4 in Dynamic Image Processing Apparatus)

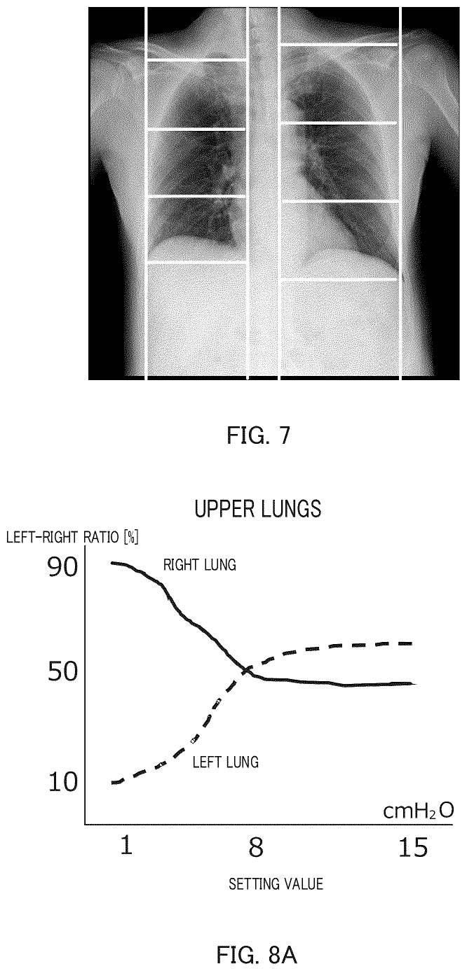

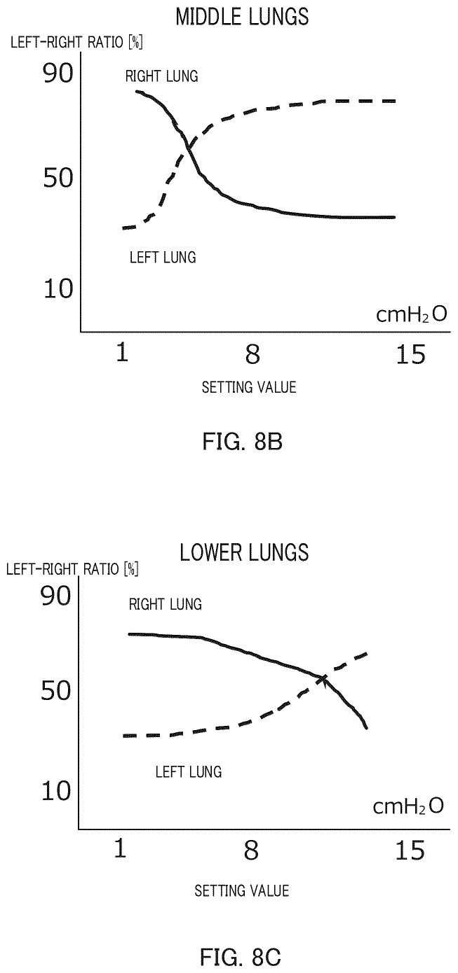

FIG. 7 is a diagram illustrating an example in which the lung fields are divided into a plurality of regions in a dynamic image imaged by dynamic image imaging apparatus 200. FIGS. 8A to 8C are graphs illustrating, with respect to a plurality of dynamic images at each different setting value of respirator 300, left-right ratios in association with the different setting value, where the left-right ratios are obtained as ratios between signal change amounts corresponding to divided regions of the left and right lungs extracted in the PL mode. FIG. 8A is a graph for upper lungs (upper lobe), FIG. 8B is a graph for middle lungs (middle lobe), and FIG. 8C is a graph for lower lungs (lower lobe).

FIG. 7 is an example in which dynamic image processing apparatus 100 divides the lung fields into six regions of an upper left region, an upper right region, a middle left region, a middle right region, a lower left region, and a lower right region in a dynamic image imaged by dynamic image imaging apparatus 200.

Note that, dynamic image processing apparatus 100 is not necessarily perform the subdivision in the example illustrated in FIG. 7, and may divide the lung fields into m regions horizontally and n regions vertically (where m×n is an integer of two or more).

The present processing example is different only in the regions of the lung fields to be processed, and the processing itself is the same as processing example 1. Accordingly, a description overlapping with processing example 1 will be omitted.

Here, as illustrated in FIGS. 8A to 8C, the left-right ratios between signal change amounts are obtained in the upper, middle, and lower lungs, respectively, but for example, the upper-middle-lower ratios between signal change amounts may also be obtained in the left and right lungs, respectively.

The present processing example is useful, for example, in a case where a part of the lungs has a lesion such as atelectasis. For example, it is assumed that there is an atelectasis lesion in the middle right lung. In the present processing example, in the middle right lung and the middle left lung, the left-right ratios between signal change amounts with respect to different setting values are obtained and graphed (see FIG. 8B), and thus, it is possible to present information in consideration of a lesion in order to set an optimum setting value of respirator 300.

### (Processing Example 5 in Dynamic Image Processing Apparatus)

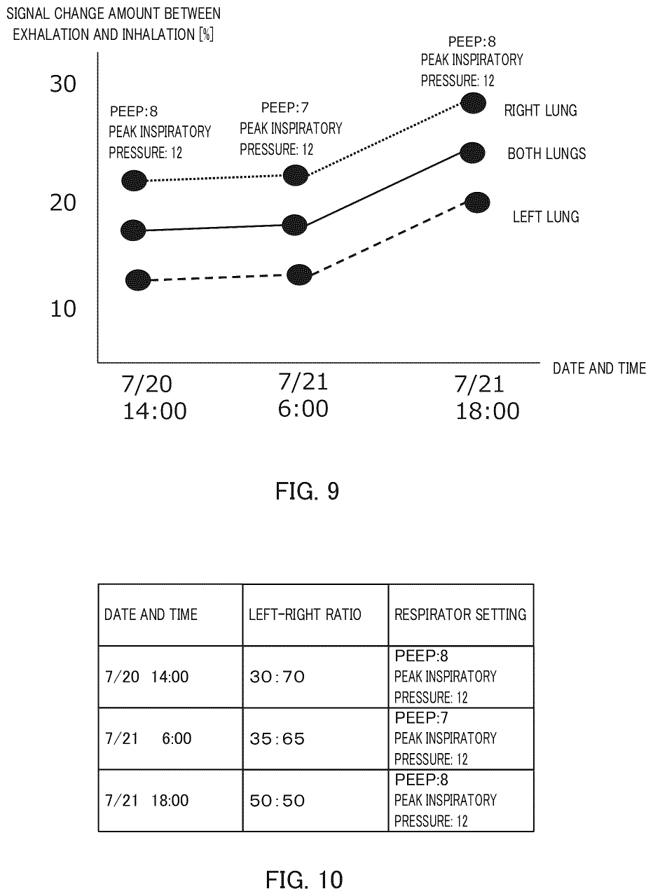

FIG. 9 is a graph illustrating, with respect to a plurality of dynamic image imaged at different dates and times, signal change amounts between exhalation and inhalation in association with the dates and times, where the signal change amounts between exhalation and inhalation are obtained for the respective signal change amounts corresponding to the left lung, right lung, and both lungs extracted in the PL mode. FIG. 10 is a table illustrating, with respect to a plurality of dynamic images imaged at different dates and times, left-right ratios and respirator settings in association with the dates and times, where the left-right ratios are obtained as ratios between signal change amounts corresponding to the left and right lungs extracted in the PL mode.

Dynamic image processing apparatus 100 may present time-series information indicating a change over time in order to set an optimum setting value of respirator 300.

In the present processing example, extraction section 101 of dynamic image processing apparatus 100 obtains, with respect to dynamic images which are imaged at different dates and times and in which the setting values of respirator 300 are the same or close to each other, signal change amounts between exhalation and inhalation for the respective signal change amounts corresponding to the left lung, right lung, and both lungs extracted in the PL mode.

Then, as illustrated in FIG. 9, extraction section 101 graphs the signal change amounts between exhalation and inhalation in the left lung, right lung, and both lungs with respect to the imaging dates and times. The graph illustrated in FIG. 9 becomes information on setting values of respirator 300 extracted by extraction section 101. Note that, instead of the graph illustrated in FIG. 9, a table as illustrated in FIG. 10 may also be used.

The user compares the signal change amounts between exhalation and inhalation under conditions where the setting values of respirator 300 are the same or close to each other, and when the signal change amounts between exhalation and inhalation have improved with the lapse of time and date, the user can perceive the tendency of the recovery of the lungs of patient P or the tendency of the start of spontaneous breathing of patient P. That is, extraction section 101 presents time-series information indicating a change over time in order to set an optimum setting value of respirator 300.

Further, as illustrated in FIG. 10, extraction section 101 may make a table of the left-right ratios between the signal change amounts corresponding to the left and right lungs with respect to the imaging dates and times. The table illustrated in FIG. 10 becomes information on setting values of respirator 300 extracted by extraction section 101. Instead of the table illustrated in FIG. 10, a graph as illustrated in FIG. 9 may also be used.

Here, the user also compares the left-right ratios between the signal change amounts under conditions where the setting values of respirator 300 are the same or close to each other, and when the left-right ratios between the signal change amounts have improved with the lapse of time and date, the user can perceive the tendency of the recovery of the lungs of patient P or the tendency of the start of spontaneous breathing of patient P. That is, extraction section 101 presents time-series information indicating a change over time in order to set an optimum setting value of respirator 300.

In FIGS. 9 and 10, it is desirable to compare the signal change amounts between exhalation and inhalation or the left-right ratios between the signal change amounts under conditions where the setting values of respirator 300 are the same. For this reason, extraction section 101 may change the graph in FIG. 9 or the table in FIG. 10 so as to compare the signal change amounts between exhalation and inhalation or the left-right ratios between the signal change amounts under conditions where the setting values of respirator 300 are the same.

### (Processing Example 6 in Dynamic Image Processing Apparatus)

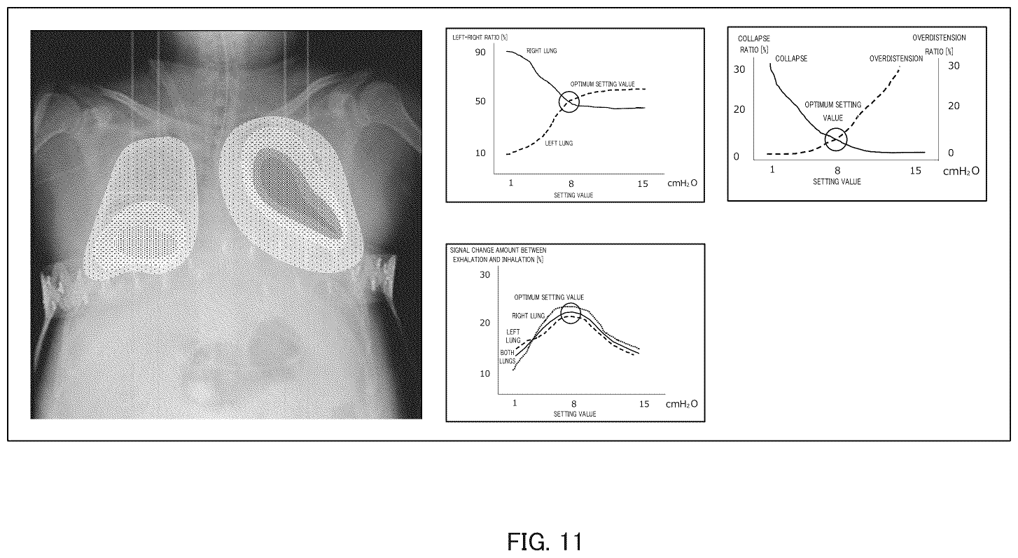

FIG. 11 is a diagram illustrating an example in which a dynamic image and a plurality of graphs are displayed at the same time.

Dynamic image processing apparatus 100 may implement a plurality of processing examples among the above-described plurality of processing examples 1 to 6 and display information extracted in the implemented processing examples together with a dynamic image imaged by dynamic image imaging apparatus 200 on input/output section 241 at the same time.

For example, in the example illustrated in FIG. 11, dynamic image processing apparatus 100 implements processing examples 1 to 3 among the above-described plurality of processing examples 1 to 6, and displays a dynamic image imaged by dynamic image imaging apparatus 200 and information (graphs) extracted in the implemented processing examples 1 to 3 at the same time on input/output section 241. The processing examples to be implemented are selected by dynamic image processing apparatus 100 or selected by a user operation, for example, according to the condition of patient P, processing conditions, the environment of the facility, and/or the like. In addition, the dynamic image may be changed from a currently displayed dynamic image to display a dynamic image imaged with another setting value by a user operation.

Any of the embodiment described above is only illustration of an exemplary embodiment for implementing the present invention, and the technical scope of the present invention shall not be construed limitedly thereby. That is, the present invention can be implemented in various forms without departing from the gist or the main features thereof.

For example, the regions to be processed by dynamic image processing apparatus 100 may be the entire left lung and the entire right lung as in processing example 1 or a plurality of divided regions obtained by dividing the lung fields as in processing example 3, but may also be regions of interest manually set by the user, that is, regions of interest.

In addition, the dynamic images to be processed may be limited such that a past dynamic image is not erroneously used as a dynamic image to be used in the processing described above. For example, the dynamic images to be processed may be limited to dynamic images of the same day, or may be limited to dynamic images within a fixed period to make it impossible to select dynamic images of other periods. In addition, the dynamic images to be processed may be limited to dynamic images imaged for confirming the optimum setting value of respirator 300, and dynamic images imaged for other purposes may be excluded.

In addition, since it is sufficient that signal change amounts can be confirmed in dynamic images imaged for confirming the optimum setting value of respirator 300, the irradiation doses in dynamic images imaged for confirming the optimum setting value of respirator 300 may be configured to have values lower than the irradiation doses in dynamic images to be imaged for other purposes. Since dynamic images for confirming the optimum setting value of respirator 300 requires a plurality of imaging operations, the irradiation doses in a plurality of imaging operations can be lowered than those in a case where imaging is performed for other purposes, by reducing the irradiation dose in one imaging operation. In particular, in a case where it is desired to acquire signal change amounts corresponding to specific regions of interest, the confirmation of dynamic images may not be necessary. The acquisition of signal change amounts may be prioritized over the image quality of dynamic images, and the irradiation doses may be configured to have low values as long as the signal change amounts of the regions of interest can be compared.

Furthermore, although the PL mode has been mainly described in the above-described embodiment, the same effect as in the above-described embodiment can be obtained by performing, for example, the same processing as the above-described processing for the DM mode (diaphragm movement amount) and the lung field area change rate (change amount) in dynamic images. Note that, the DM mode is a mode in which the movement of the diaphragm is tracked in dynamic images and the amount of the vertical movement thereof is quantified.

Although embodiments of the present invention have been described and illustrated in detail, the disclosed embodiments are made for purpose of illustration and example only and not limitation. The scope of the present invention should be interpreted by terms of the appended claims.

What is claimed is:

1. A dynamic image processing apparatus, comprising:
at least one hardware processor; and
an outputter that outputs information on a setting value of a respiratory assistance apparatus, wherein
the at least one hardware processor extracts the information by processing at least one dynamic image imaged by irradiating lungs of a subject with radiation, the subject being put on the respiratory assistance apparatus.

2. The dynamic image processing apparatus according to claim 1, wherein
the at least one hardware processor extracts the information from at least two of the dynamic images each imaged at a different setting value of the respiratory assistance apparatus.

3. The dynamic image processing apparatus according to claim 2, wherein
the at least one hardware processor determines an optimum setting value with respect to a plurality of the different setting values based on the information.

4. The dynamic image processing apparatus according to claim 3, wherein
the at least one hardware processor determines the optimum setting value by comparing the information corresponding to a left lung of the lungs with the information corresponding to a right lung of the lungs.

5. The dynamic image processing apparatus according to claim 4, wherein
the at least one hardware processor determines the optimum setting value by comparing a plurality of pieces of the information each corresponding to a plurality of regions obtained by dividing lung fields of the lungs.

6. The dynamic image processing apparatus according to claim 2, wherein:
one of the at least two dynamic images is a dynamic image when a reference setting value of the respiratory assistance apparatus is used as one of a plurality of the different setting values, and
another one of the at least two dynamic images is a dynamic image when a setting value higher or lower than the reference setting value is used as another one of a plurality of the different setting values.

7. The dynamic image processing apparatus according to claim 1, wherein
the at least one hardware processor extracts the information from the dynamic image when a reference setting value of the respiratory assistance apparatus is used as the setting value.

8. The dynamic image processing apparatus according to claim 1, wherein
the at least one hardware processor extracts, in the dynamic image, a signal change amount in a time direction in a specific time-frequency band and visualizes the signal change amount.

9. The dynamic image processing apparatus according to claim 8, wherein
the information is a graph illustrating a plurality of left-right ratios in association with a different setting value of the respiratory assistance apparatus, each of the plurality of left-right ratios being obtained as a ratio between the signal change amount corresponding to a left lung of the lungs and the signal change amount corresponding to a right lung of the lungs.

10. The dynamic image processing apparatus according to claim 8, wherein
the information is a graph illustrating a plurality of the signal change amounts between exhalation and inhalation in association with a different setting value of the respiratory assistance apparatus.

11. The dynamic image processing apparatus according to claim 8, wherein
the information is a graph illustrating a plurality of collapse ratios and a plurality of overdistension ratios in association with a different setting value of the respiratory assistance apparatus, each of the plurality of collapse ratios being a ratio of collapse to an entire lung field, each of the plurality of overdistension ratios being a ratio of overdistension to the entire lung field.

12. The dynamic image processing apparatus according to claim 8, wherein
the information is a graph or a table that illustrates a plurality of left-right ratios in time series, each of the plurality of left-right ratios being obtained as a ratio between the signal change amount corresponding to a left lung of the lungs and the signal change amount corresponding to a right lung of the lungs.

13. The dynamic image processing apparatus according to claim 8, wherein
the information is a graph or a table that illustrates a plurality of the signal change amounts between exhalation and inhalation in time series.

14. The dynamic image processing apparatus according to claim 8, wherein:
the information includes at least two pieces of information among
a graph illustrating a plurality of left-right ratios in association with a different setting value of the respiratory assistance apparatus, each of the plurality of left-right ratios being obtained as a ratio between the signal change amount corresponding to a left lung of the lungs and the signal change amount corresponding to a right lung of the lungs,
a graph illustrating a plurality of the signal change amounts between exhalation and inhalation in association with the different setting value,
a graph illustrating a plurality of collapse ratios and a plurality of overdistension ratios in association with the different setting value, each of the plurality of collapse ratios being a ratio of collapse to an entire lung field, each of the plurality of overdistension ratios being a ratio of overdistension to the entire lung field,
a graph or a table that illustrates a plurality of left-right ratios in time series, each of the plurality of left-right ratios being obtained as a ratio between the signal change amount corresponding to a left lung of the lungs and the signal change amount corresponding to a right lung of the lungs, and
a graph or a table that illustrates a plurality of the signal change amounts between exhalation and inhalation in time series, and
the outputter outputs the at least two pieces of information.

15. A mobile vehicle, comprising:
the dynamic image processing apparatus according to claim 1;
a dynamic image imaging apparatus that images the at least one dynamic image and inputs the at least one dynamic image to the dynamic image processing apparatus; and
a cart on which the dynamic image processing apparatus and the dynamic image imaging apparatus are mounted and which is configured to be movable.

16. A dynamic image processing method, comprising:
extracting information on a setting value of a respiratory assistance apparatus by processing at least one dynamic image imaged by irradiating lungs of a subject with radiation, the subject being put on the respiratory assistance apparatus; and
outputting the information.

17. A non-transitory computer-readable recording medium storing a dynamic image processing program, the dynamic image processing program causing a computer to execute:
extracting information on a setting value of a respiratory assistance apparatus by processing at least one dynamic image imaged by irradiating lungs of a subject with radiation, the subject being put on the respiratory assistance apparatus; and
outputting the information.
